(19) United States
(12) Patent Application Publication
(10) Pub. No.: US 2025/0172237 A1
(43) Pub. Date: May 29, 2025

(54) MOUNTING BRACKET FOR ELECTRICAL BOX

(71) Applicant: S-P Products, Inc., Elk Grove Village, IL (US)

(72) Inventors: Kevin Hilzinger, Imperial, MO (US); Mikel Bishka, Wheaton, IL (US)

(21) Appl. No.: 18/962,574

(22) Filed: Nov. 27, 2024

Related U.S. Application Data
(60) Provisional application No. 63/603,458, filed on Nov. 28, 2023.

(51) Int. Cl. F16M 13/02; H02G 3/08

(52) U.S. Cl. CPC F16M 13/02; H02G 3/08

(57) ABSTRACT

An improved arrangement for mounting an electrical box comprises a unique, unitary mounting bracket. Notably, the mounting bracket has an initial planar configuration, comprising a single metallic component, thus facilitating convenient manufacture, and efficient use. The mounting bracket comprises a box section formed from four parallel, box elements initially arranged in co-planar relationship with each other. The mounting bracket further comprises a pair of stud sections, respectively extending from a pair of the box elements which are spaced from each other by an intermediate one of the box elements.

### CROSS-REFERENCE TO RELATED APPLICATION

This application is a non-provisional, which claims priority of Provisional Application Ser. No. 63/603,458 filed Nov. 28, 2023, the disclosure of which is hereby incorporated by reference in their entireties.

### FIELD OF THE INVENTION

The present invention relates generally to electrical boxes and like components for housing wire and the like in a building structure, and more particularly to an arrangement for mounting an electrical box or other component comprising a unitary, one-piece mounting bracket, which can be deformed from a generally planar configuration to provide a box section, and a stud section to facilitate electrical box installation.

### BACKGROUND OF THE INVENTION

Building structures typically include electrical boxes for housing wiring and associated electrical components. Electrical conduit and like elements are typically joined to the electrical box, with suitable junctions for the associated wiring provided in the box.

Mounting electrical boxes can be time-consuming, and in some instances requires accessing components and support structures which may be elevated, or otherwise difficult to access.

The present invention contemplates an improved arrangement for mounting an electrical box, which facilitates convenient and efficient mounting and placement, such as along a building stud or the like. The arrangement need not be solely utilized for securing a box, but rather as an addition of supporting means, whether that be a box, MC cable, conduit, or “J” hooks for low voltage cabling.

### SUMMARY OF THE INVENTION

An improved arrangement for mounting an electrical box comprises a unique, unitary mounting bracket. Notably, the mounting bracket has an initial planar configuration, comprising a single metallic component, thus facilitating convenient manufacture, and efficient use.

The mounting bracket comprises a box section formed from four parallel, box elements initially arranged in co-planar relationship with each other. The mounting bracket further comprises a pair of stud sections, respectively extending from a pair of the box elements which are spaced from each other by an intermediate one of the box elements.

The mounting bracket is deformable from the initial planar configuration to configure the box elements in a rectangular configuration, to thereby form the box section in a tubular configuration. In this configuration, the pair of stud sections extend from the box section in spaced apart, parallel relationship to thereby facilitate attachment of the stud sections to an associated stud or other building component. Attachment of the stud sections to the associated stud thereby mounts the mounting bracket for subsequent attachment of an associated electrical box thereto.

In the illustrated embodiment, the box section of the mounting bracket includes at least one tab member positioned along one edge of the box section, in the initial planar configuration of the mounting bracket. The bracket further includes at least one tab slot defined by another, opposite edge of the box section. Each tab member is positionable in a respective one of the tab slots when the mounting bracket is deformed to configure the box elements in the rectangular configuration.

In the preferred form, the box section of the mounting bracket defines fold lines between adjacent ones of the box elements. Each fold line is defined by a plurality of spaced apart openings, to thereby facilitate bending of the box section from the initial planar configuration to the tubular configuration. Similarly, each of the stud sections defines at least one fold line, extending transversely thereof, to facilitate bending of the stud sections at one or more locations

Preferably, each of the box elements and the stud sections defines a plurality of openings for receiving mechanical fasteners therethrough.

The present mounting bracket is an innovative new product that has the potential to revolutionize the installation methods of electrical wiring and securing junction boxes in commercial and industrial settings, making the process faster and cost-effective. The current process for installing an electrical junction box in commercial buildings typically requires the electrician to secure the box to building steel using beam clamps, often at heights of up to 15 feet in the air. It is time-consuming, dirty and potentially difficult.

During a remodel, it is even more difficult, because the electrician doesn't know what junction box at which a circuit originates, and components may be blocked by other trades including plumbing lines, steam lines, or duct work. The present bracket offers a quick and easy option for securing boxes as well as conduit and cabling to the studs directly, either before drywall or after, just above the ceiling. This enables their work to be located at a convenient, accessible and consistent height throughout the building. This method proves to ultimately make the process of installing junction boxes easier and faster than the current process. All of this adds up to significant savings for electrical contractors.

Typically, most junction box installations require the electrician to either have to wait for drywall to be installed in order to mount their box to the finished wall or, if they can't wait, which is more often the case, secure the box to building steel using beam clamps, often at heights of up to 15 feet in the air. This requires a ladder in excess of 10 feet making this precarious work, just to install a box. Additionally, the electrician may have to scrape off fireproofing and insulation from the structural steel just to attach the junction box with beam clamps, resulting in an undesirable shower of insulation and potential objections from fire officials. If junction boxes are mounted all the way up to building steel, electricians have difficulty accessing these boxes when other trades install their systems. For example, duct work, plumbing, and even steam lines could potentially make the junction box completely inaccessible.

During a remodel it is even more difficult, because the electrician doesn't know where the boxes are. It can take hours to locate the boxes in a large building, and if the building is occupied, can cause disruption for tenants.

The present mounting bracket offers a cost-effective solution for securing boxes up above an acoustic ceiling for power feed and switch leg disbursement. Simply open the ceiling tile and attach the bracket to the stud nearest to any room entry. Junction boxes, conduit, and MC Cable can all now be secured at a safer location right above an acoustic ceiling. Better yet, the Electro-Post also allows for prefabrication in a controlled and safe environment.

This invention saves the electrical contractor money because the junction box can now be installed in a fraction of the time-up to 5 times faster than the current techniques. Desirably, the present bracket can be delivered in a flat, generally planar configuration prior to bending for use, making it easy to store and ship. The “Fold & Go” design ensures a quick and easy installation. It is no longer required to use two ladders and climb just to secure a junction box to the steel with beam clamps. Pre-punched holes allow for easy installation, which means that very few tools are needed, and with an array of options available in one product design, the present bracket can be adapted to a variety of applications. The present mounting bracket ideally can work for any building or any location with an acoustic lay-in ceiling. Not only can the bracket secure junction boxes, but it can also be used as a means of support for electrical conduit and MC cable. This bracket can additionally advantageously used in a residential application.

Advantages of the present invention include time savings for the electrician since he simply needs to open the ceiling tile and have workable, convenient access to the associated junction box. The present bracket can be folded into shape very quickly and can take just a few minutes to install. “Fold-and-go” design permits the bracket to be readily prepared for use and does not require specialized tools or the like for installation.

Additionally, the present bracket allows the electrician to install a junction box on opposite sides of the pre-punched post, i.e., (2) boxes with every post, ensuring that different voltages or power sources are not combined in the same box. For example, one box can be reserved for 120v branch power, while the other can house 277v lighting.

The bracket allows for cost-effective prefabrication in a controlled environment and leads to a lower Experience Modification Rate (EMR) and lower worker compensation insurance premiums. Thus, a main benefit of the present invention to the potential user buyer (the electrical contractor) is the ultimate cost savings that are available, due to the mounting bracket being a faster, easier and most cost-effective solution than attaching the junction boxes all the way up to building steel. For any average sized, to larger size contractor that is working on hundreds of buildings each year, employing thousands of electricians, the savings could run into tens of thousands of dollars per year. Such savings can be used to boost profits or make companies more competitive in the market.

Notably, research has shown that the electrical contracting industry in the United States is made up of over 70,000 electrical firms and is valued at over $160 billion annually. The present mounting bracket has the potential for beneficial use by commercial and industrial-type contractors, because they typically work in settings that include acoustical ceiling environments.

Other features and advantages of the present invention will become readily apparent from the following detailed description, the accompanying drawings, and the appended claims.

### BRIEF DESCRIPTION OF THE DRAWINGS

FIG. 1 is a perspective view of the present mounting bracket for an associated electrical box showing the bracket if a folded configuration for use;

FIG. 2 is a perspective view of the present mounting bracket in its initial generally planar configuration prior to folding for use;

FIG. 3 is a diagrammatic view of the present mounting bracket shown in its generally planar configuration prior to folding;

FIG. 4 is a diagrammatic view of the present mounting bracket shown in a folded configuration for use; and

FIG. 5 is a diagrammatic view of the present mounting bracket, including a sequence of views showing folding of the present bracket for use, including folding of stud sections thereof for various mounting configurations.

### DETAILED DESCRIPTION OF THE INVENTION

While the present invention is susceptible of embodiment in various forms, there is shown in the drawings, and will hereinafter be described, a presently preferred embodiment of the invention, with the understanding that the present disclosure is to be considered as an exemplification of the invention, and is not intended to limit the invention to the specific embodiment illustrated.

An improved arrangement for mounting an electrical box comprises a unique, unitary mounting bracket 10. Notably, the mounting bracket 10 has an initial planar configuration, comprising a single metallic component, thus facilitating convenient manufacture, and efficient use.

The mounting bracket 10 comprises a box section formed from four parallel, box elements 12 initially arranged in co-planar relationship with each other. The mounting bracket 10 further comprises a pair of stud sections, 14, 14, respectively extending from a pair of the box elements 12 which are spaced from each other by an intermediate one of the box elements.

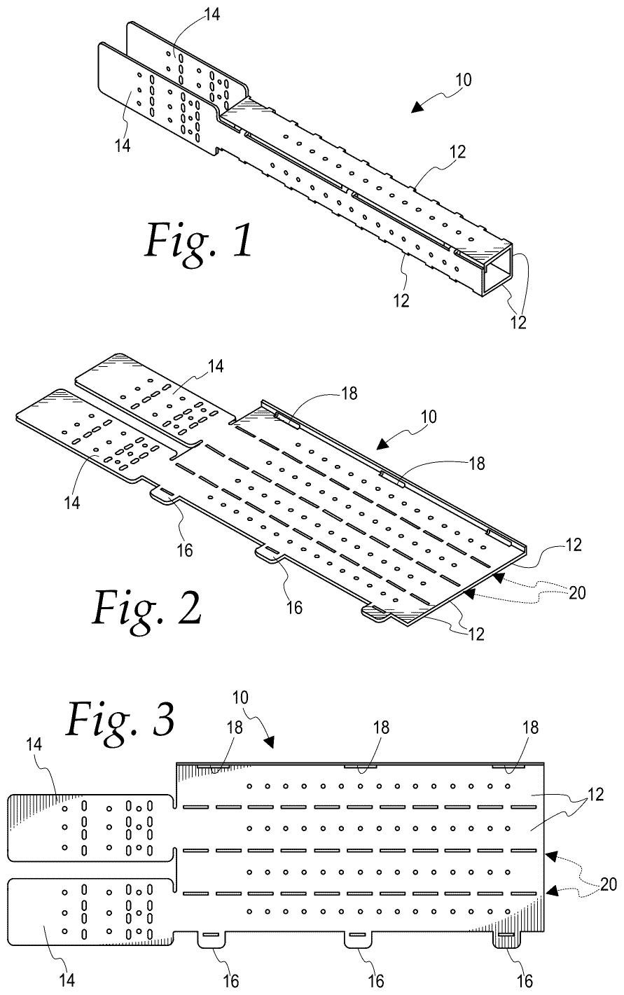

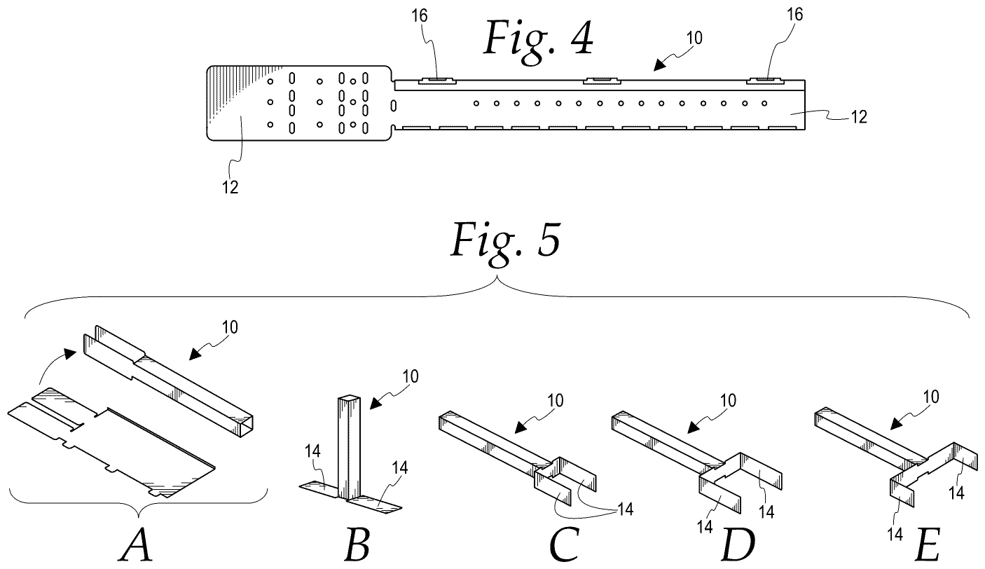

The mounting bracket 10 is deformable from the initial planar configuration, shown in FIGS. 2 and 3, to configure the box elements 12 in a rectangular configuration, to thereby form the box section in a tubular configuration. In this configuration, the pair of stud sections 14, 14 extend from the box section in spaced apart, parallel relationship to thereby facilitate attachment of the stud sections to an associated stud or other building component. Attachment of the stud sections to the associated stud thereby mounts the mounting bracket for subsequent attachment of an associated electrical box thereto.

In the illustrated embodiment, the box section of the mounting bracket 10 includes at least one tab member 16 positioned along one edge of the box section, in the initial planar configuration of the mounting bracket. The bracket further includes at least one tab slot 18 defined by another, opposite edge of the box section. Each tab member 16 is positionable in a respective one of the tab slots 18 when the mounting bracket 10 is deformed to configure the box elements in the rectangular configuration. Thereafter, the tab members 16 can be deformed so that they are retained in the respective tab slots 18, thus maintaining the bracket 10 in its folded configuration.

In the preferred form, the box section of the mounting bracket defines fold lines 20 between adjacent ones of the box elements 12. Each fold line 20 is defined by a plurality of spaced apart openings, to thereby facilitate bending of the box section from the initial planar configuration to the tubular configuration. Similarly, each of the stud sections 14, 14 defines at least one fold line, extending transversely thereof, to facilitate bending of the stud sections at one or more locations.

FIG. 5 is a diagrammatic view of the mounting bracket 10, including: View A showing folding of the bracket from a generally planar configuration to its folded, box-like configuration; View B showing stud sections 14 folded outwardly to secure the bracket 10 to the face of an associated stud for mounting; View C the stud sections 14 folded to a spacing such as 2.5 inch for mounting; View D showing the stud sections 14 folded to a spacing such as 3.625 inch; and View E showing the stud sections folded such as for 6.0 inch spacing.

Preferably, each of the box elements and the stud sections defines a plurality of openings for receiving mechanical fasteners therethrough.

From the foregoing, numerous modifications and variations can be effected without departing from the true spirit and scope of the novel concept of the present invention. It is to be understood that no limitations with respect to the specific embodiment disclosed herein are intended or should be inferred. The disclosure is intended to cover, by the appended claims, all such modifications as fall within the scope of the claims.

1. An arrangement for mounting an electrical box, comprising:
a unitary mounting bracket;
said mounting bracket having an initial planar configuration, comprising a single metallic component;
said mounting bracket comprising a box section formed from four parallel, box elements initially arranged in co-planar relationship with each other;
said mounting bracket further comprising a pair of stud sections respectively extending from a pair of said box elements, spaced from each other by an intermediate one of said box elements; and
said mounting bracket being deformable from said initial planar configuration to configure said box elements in a rectangular configuration to form a said box section in a tubular configuration, said pair of stud sections extending from said box section in spaced apart, parallel relationship to facilitate attachment of said stud sections to an associated stud or other building component, to thereby mount said mounting bracket for subsequent attachment of and electrical box thereto.

2. An arrangement for mounting an electrical box in accordance with claim 1, wherein
said box section of said mounting bracket includes at least one tab member positioned along one edge of said box section in the initial planar configuration of said mounting bracket, and at least one tab slot defined by another edge of said box section, opposite said one edge;
each said tab member being positionable in a respective one of said tab slots when said mounting bracket is deformed to configure said box elements in said rectangular configuration.

3. An arrangement for mounting an electrical box in accordance with claim 1, wherein
said box section of said mounting bracket defines fold lines between adjacent ones of said box elements;
each said fold line being defined by a plurality of spaced apart openings, to facilitate bending of said box section from said initial planar configuration to said tubular configuration.

4. An arrangement for mounting an electrical box in accordance with claim 1, wherein
each of said stud sections defines at least one fold line extending transversely thereof to facilitate bending of said stud sections at one or more locations.

5. An arrangement for mounting an electrical box in accordance with claim 1, wherein
each of box elements and said stud sections defines a plurality of openings for receiving mechanical fasteners therethrough.

6. A method for mounting an electrical box, comprising the steps of:
providing a unitary mounting bracket having an initial planar configuration, comprising a single metallic component, said mounting bracket comprising four parallel, box elements initially arranged in co-planar relationship with each other;
said mounting bracket further comprising a pair of stud sections respectively extending from a pair of said box elements, spaced from each other by an intermediate one of said box elements;
deforming said mounting bracket from said initial planar configuration to configure said box elements of said mounting bracket in a box section having rectangular configuration, to thereby form said box section in a tubular configuration, said pair of stud sections extending from said box section in spaced apart, parallel relationship to facilitate attachment of said stud sections to an associated stud or other building component, to thereby mount said mounting bracket for subsequent attachment of and electrical box thereto.

7. A method for mounting an electrical box in accordance with claim 6, wherein
said box section of said mounting bracket includes at least one tab member positioned along one edge of said box section in the initial planar configuration of said mounting bracket, and at least one tab slot defined by another edge of said box section, opposite said one edge, and
positioning each said tab member in a respective one of said tab slots when said mounting bracket is deformed to configure said box elements in said rectangular configuration.

8. A method for mounting an electrical box in accordance with claim 6, including
deforming each of stud sections to facilitate fitment of said stud sections to said associated stud for mounting said mounting bracket thereto.
